(19) United States
(12) Patent Application Publication
(10) Pub. No.: US 2019/0004807 A1
(43) Pub. Date: Jan. 3, 2019

(54) STREAM PROCESSOR WITH OVERLAPPING EXECUTION

(71) Applicant: Advanced Micro Devices, Inc., Sunnyvale, CA (US)

(72) Inventors: Jiasheng Chen, Orlando, FL (US); Qingcheng Wang, Shanghai (CN); Yunxiao Zou, Shanghai (CN); Bin He, Oviedo, FL (US); Jian Yang, Shanghai (CN); Michael J. Mantor, Orlando, FL (US); Brian D. Emberling, Palo Alto, CA (US)

(21) Appl. No.: 15/657,478

(22) Filed: Jul. 24, 2017

(30) Foreign Application Priority Data
Jun. 30, 2017 (CN) 201710527119.8

(51) Int. Cl. G06F 9/38

(52) U.S. Cl. CPC G06F 9/3851; G06F 9/3885

(57) ABSTRACT

Systems, apparatuses, and methods for implementing a stream processor with overlapping execution are disclosed. In one embodiment, a system includes at least a parallel processing unit with a plurality of execution pipelines. The processing throughput of the parallel processing unit is increased by overlapping execution of multi-pass instructions with single pass instructions without increasing the instruction issue rate. A first plurality of operands of a first vector instruction are read from a shared vector register file in a single clock cycle and stored in temporary storage. The first plurality of operands are accessed and utilized to initiate multiple instructions on individual vector elements on a first execution pipeline in subsequent clock cycles. A second plurality of operands are read from the shared vector register file during the subsequent clock cycles to initiate execution of one or more second vector instructions on the second execution pipeline.

### PRIORITY INFORMATION

This application claims benefit of priority to Chinese Application No. 201710527119.8, entitled “STREAM PROCESSOR WITH OVERLAPPING EXECUTION”, filed Jun. 30, 2017, the entirety of which is incorporated herein by reference in its entirety.

### BACKGROUND

### Description of the Related Art

Many different types of computing systems include vector processors or single-instruction, multiple-data (SIMD) processors. Tasks can execute in parallel on these types of parallel processors to increase the throughput of the computing system. It is noted that parallel processors can also be referred to herein as “stream processors”. Attempts to improve the throughput of stream processors are continually being undertaken. The term “throughput” can be defined as the amount of work (e.g., number of tasks) that a processor can perform in a given period of time. One technique for improving the throughput of stream processors is by increasing the instruction issue rate. However, increasing the instruction issue rate of a stream processor typically results in increased cost and power consumption. It can be challenging to increase the throughput of a stream processor without increasing the instruction issue rate.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system.

FIG. 2 is a block diagram of one embodiment of a stream processor with multiple types of execution pipelines.

FIG. 3 is a block diagram of another embodiment of a stream processor with multiple types of execution pipelines.

FIG. 4 is a timing diagram of one embodiment of overlapping execution on execution pipelines.

FIG. 5 is a generalized flow diagram illustrating one embodiment of a method for overlapping execution in multiple execution pipelines.

FIG. 6 is a generalized flow diagram illustrating one embodiment of a method for sharing a vector register file among multiple execution pipelines.

FIG. 7 is a generalized flow diagram illustrating one embodiment of a method for determining on which pipeline to execute a given vector instruction.

FIG. 8 is a generalized flow diagram illustrating one embodiment of a method for implementing an instruction arbiter.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for increasing processor throughput are disclosed herein. In one embodiment, processor throughput is increased by overlapping execution of multi-pass instructions with single pass instructions on separate execution pipelines without increasing the instruction issue rate. In one embodiment, a system includes at least a parallel processing unit with a plurality of execution pipelines. The parallel processing unit includes at least two different types of execution pipelines. These different types of execution pipelines can be referred to generally as first and second types of execution pipelines. In one embodiment, the first type of execution pipeline is a transcendental pipeline for performing transcendental operations (e.g., exponentiation, logarithm, trigonometric) and the second type of execution pipeline is a vector arithmetic logic unit (ALU) pipeline for performing fused multiply-add (FMA) operations. In other embodiments, the first and/or second types of processing pipelines can be other types of execution pipelines which process other types of operations.

In one embodiment, when the first type of execution pipeline is a transcendental pipeline, an application executing on the system can improve the shader performance for 3D graphics which have a high number of transcendental operations. The traditional way of fully utilizing the compute throughput of multiple execution pipelines is by implementing a multi-issue architecture with a complex instruction scheduler and a high bandwidth vector register file. However, the systems and apparatuses described herein include an instruction scheduler and a vector register file which are compatible with a single issue architecture.

In one embodiment, a multi-pass instruction (e.g., transcendental instruction) would take one cycle for the operands to be read into the first execution pipeline and to initiate execution of a first vector element, but starting from the next cycle, the execution of the second vector element could be overlapped with instructions on the second execution pipeline if there are no dependencies between the instructions. In other embodiments, the processor architecture can be implemented and applied to other multi-pass instructions (e.g., double precision floating point instructions). Utilizing the techniques described herein, the throughput of a processor with multiple execution units is increased without increasing the instruction issue rate.

In one embodiment, a first plurality of operands for multiple vector elements of a vector instruction, to be executed by the first execution pipeline, are read from the vector register file in a single clock cycle and stored in temporary storage. In one embodiment, the temporary storage is implemented by using flip-flops coupled to the outputs of the vector register file. The operands are accessed from the temporary storage and utilized to initiate execution of multiple operations on the first execution pipeline in subsequent clock cycle. Simultaneously, the second execution pipeline accesses a second plurality of operands from the vector register file to initiate execution of one or more vector operations on the second execution pipeline during the subsequent clock cycles. In one embodiment, the first execution pipeline has a separate write port to the vector destination cache to allow for co-execution with the second execution pipeline.

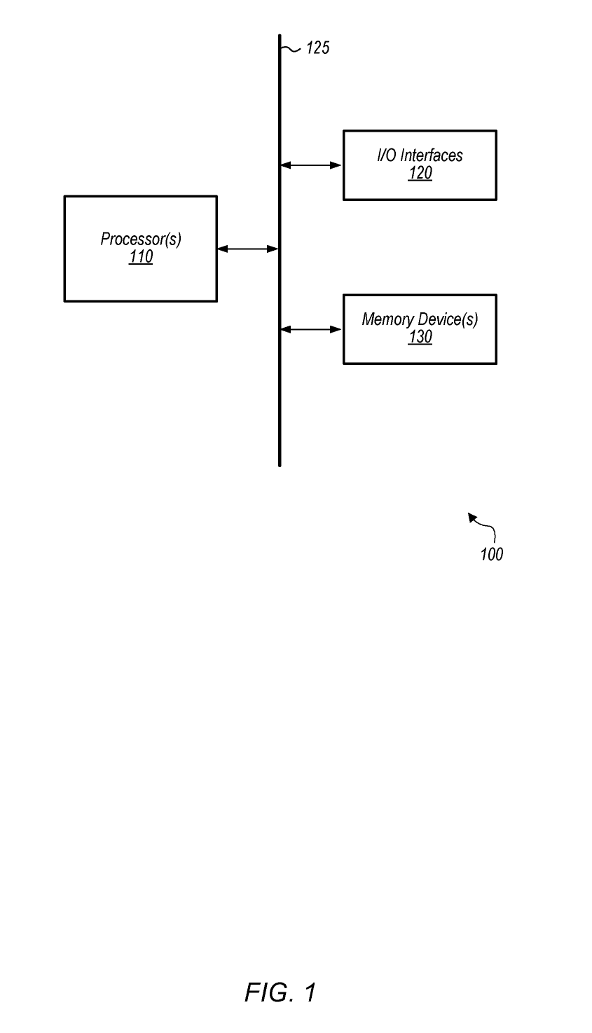

Referring now to FIG. 1, a block diagram of one embodiment of a computing system 100 is shown. In one embodiment, computing system 100 includes at least processor(s) 110, input/output (I/O) interfaces 120, bus 125, and memory device(s) 130. In other embodiments, computing system 100 can include other components and/or computing system 100 can be arranged differently.

Processors(s) 110 are representative of any number and type of processing units (e.g., central processing unit (CPU), graphics processing unit (GPU), digital signal processor (DSP), field programmable gate array (FPGA), application specific integrated circuit (ASIC)). In one embodiment, processor(s) 110 includes a vector processor with a plurality of stream processors. Each stream processor can also be referred to as a processor or a processing lane. In one embodiment, each stream processor includes at least two types of execution pipelines that share a common vector register file. In one embodiment, the vector register file includes multi-bank high density random-access memories (RAMs). In various embodiments, execution of instructions can be overlapped on the multiple execution pipelines to increase throughput of the stream processors. In one embodiment, the first execution pipeline has a first write port to a vector destination cache and the second execution pipeline has a second write port to the vector destination cache to allow both execution pipelines to write to the vector destination cache in the same clock cycle.

Memory device(s) 130 are representative of any number and type of memory devices. For example, the type of memory in memory device(s) 130 can include Dynamic Random Access Memory (DRAM), Static Random Access Memory (SRAM), NAND Flash memory, NOR flash memory, Ferroelectric Random Access Memory (FeRAM), or others. Memory device(s) 130 are accessible by processor(s) 110. I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices can be coupled to I/O interfaces 120. Such peripheral devices include (but are not limited to) displays, keyboards, mice, printers, scanners, joysticks or other types of game controllers, media recording devices, external storage devices, network interface cards, and so forth.

In various embodiments, computing system 100 can be a computer, laptop, mobile device, server or any of various other types of computing systems or devices. It is noted that the number of components of computing system 100 can vary from embodiment to embodiment. There can be more or fewer of each component/subcomponent than the number shown in FIG. 1. It is also noted that computing system 100 can include other components not shown in FIG. 1.

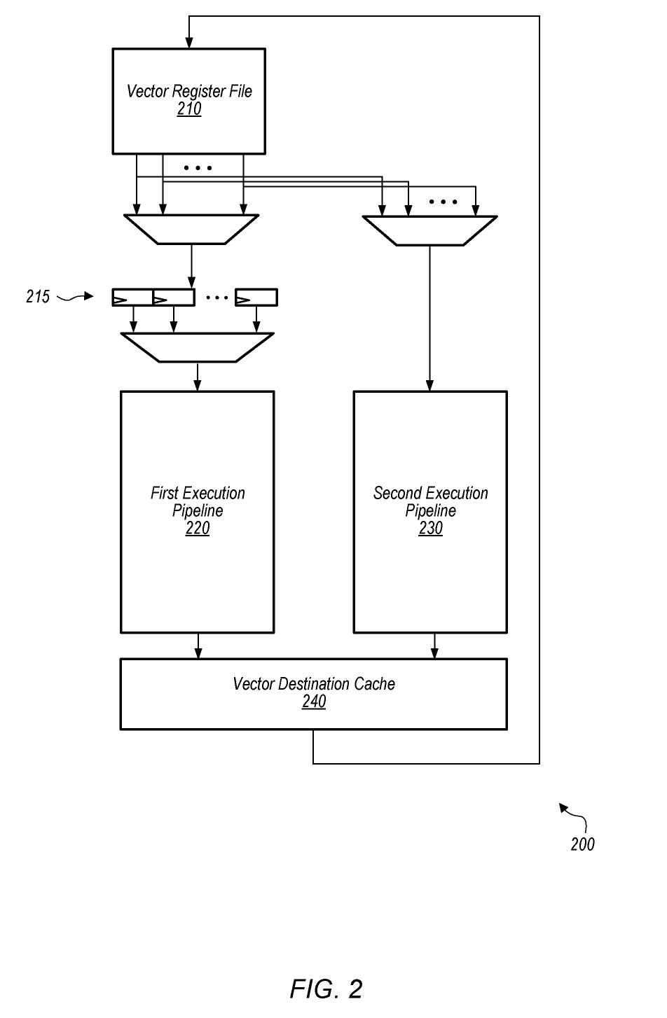

Turning now to FIG. 2, a block diagram of one embodiment of a stream processor 200 with multiple types of execution pipelines is shown. In one embodiment, stream processor 200 includes vector register file 210 which is shared by first execution pipeline 220 and second execution pipeline 230. In one embodiment, vector register file 210 is implemented with multiple banks of random-access memory (RAM). Although not shown in FIG. 2, in some embodiments, vector register file 210 can be coupled to an operand buffer to provide increased operand bandwidth to first execution pipeline 220 and second execution pipeline 230.

In one embodiment, in a single cycle, a plurality of source data operands (or operands) for a vector instruction are read out of vector register file 210 and stored in temporary storage 215. In one embodiment, temporary storage 215 is implemented with a plurality of flip-flops. Then, in subsequent cycles, operands are retrieved out of temporary storage 215 and provided to individual instructions which are initiated for execution on first execution pipeline 220. Since first execution pipeline 220 does not access vector register file 210 during these subsequent cycles, second execution pipeline 230 is able to access vector register file 210 to retrieve operands to execute vector instructions which overlap with the individual instructions being executed by first execution pipeline 220. First execution pipeline 220 and second execution pipeline 230 utilize separate write ports to write results to vector destination cache 240.

In one embodiment, first execution pipeline 220 is a transcendental execution pipeline and second execution pipeline 230 is a vector arithmetic logic unit (VALU) pipeline. The VALU pipeline can also be implemented as a vector fused multiply-add (FMA) pipeline. In other embodiments, first execution pipeline 220 and/or second execution pipeline 230 can be other types of execution pipelines. It should be understood that while two separate types of execution pipelines are shown in stream processor 200, this is meant to illustrate one possible embodiment. In other embodiments, stream processor 200 can include other numbers of different types of execution pipelines which are coupled to a single vector register file.

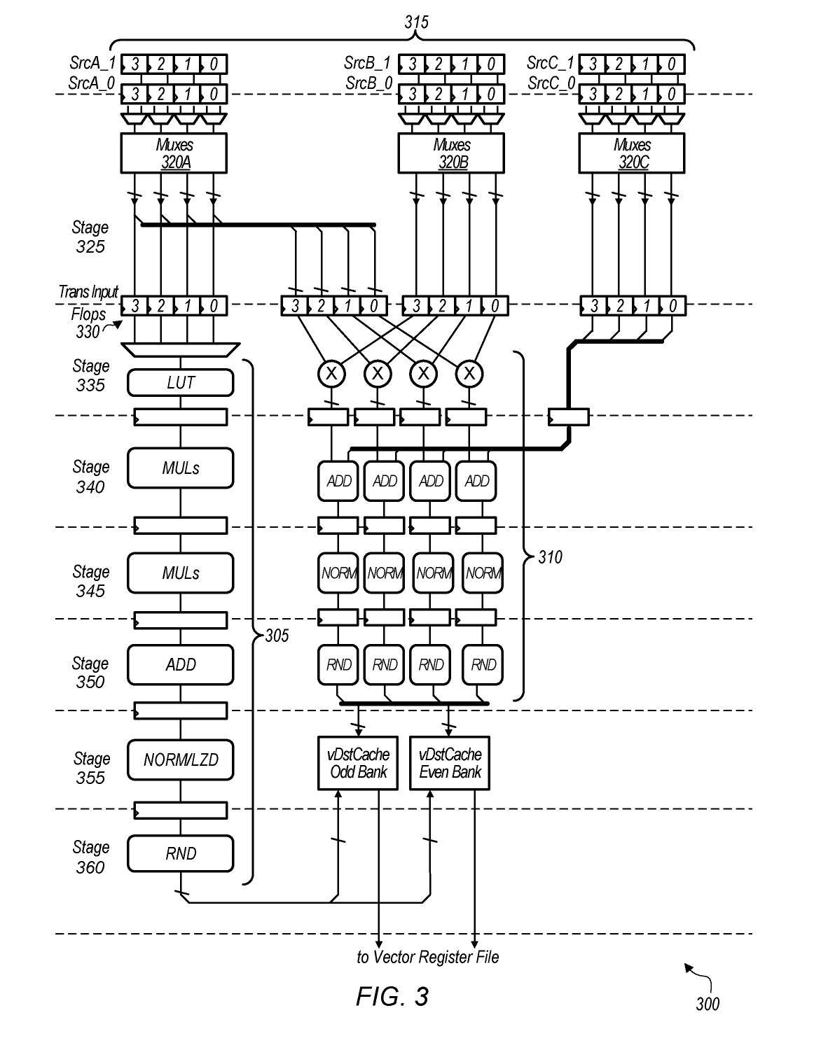

Referring now to FIG. 3, a block diagram of another embodiment of a stream processor 300 with multiple types of execution pipelines is shown. In one embodiment, stream processor 300 includes transcendental execution pipeline 305 and fused multiply-add (FMA) execution pipeline 310. In some embodiments, stream processor 300 can also include a double-precision floating point execution pipeline (not shown). In other embodiments, stream processor 300 can include other numbers of execution pipelines and/or other types of execution pipelines. In one embodiment, stream processor 300 is a single-issue processor.

In one embodiment, stream processor 300 is configured to execute vector instructions which have a vector width of four elements. It should be understood that while the architecture of stream processor 300 is shown to include four elements per vector instruction, this is merely indicative of one particular embodiment. In other embodiments, stream processor 300 can include other numbers (e.g., 2, 8, 16) of elements per vector instruction. Additionally, it should be understood that the bit widths of buses within stream processor 300 can be any suitable values which can vary according to the embodiment.

In one embodiment, transcendental execution pipeline 305 and FMA execution pipeline 310 share instruction operand buffer 315. In one embodiment, instruction operand buffer 315 is coupled to a vector register file (not shown). When a vector instruction targeting transcendental execution pipeline 305 is issued, the operands for the vector instruction are read in a single cycle and stored in temporary storage (e.g., flip-flops) 330. Then, in the next cycle, the first operation of the vector instruction accesses one or more first operands from the temporary storage 330 to initiate execution of the first operation on transcendental execution pipeline 305. The FMA execution pipeline 310 can access instruction operand buffer 315 in the same cycle that the first operation is initiated on transcendental execution pipeline 305. Similarly, in subsequent cycles, additional operands are accessed from flops 330 to initiate execution of operations for the same vector instruction on transcendental execution pipeline 305. In other words, the vector instruction is converted into multiple scalar instructions which are initiated in multiple clock cycles on transcendental execution pipeline 305. Meanwhile, while multiple scalar operations are being launched on transcendental execution pipeline 305, overlapping instructions can be executed on FMA execution pipeline 310.

Different stages of the pipelines are shown for both transcendental execution pipeline 305 and FMA execution pipeline 310. For example, stage 325 involves routing operands from the multiplexors (“muxes”) 320A-B to the inputs of the respective pipelines. Stage 335 involves performing a lookup to a lookup table (LUT) for transcendental execution pipeline 305 and performing a multiply operation on multiple operands for multiple vector elements for FMA execution pipeline 310. Stage 340 involves performing multiplies for transcendental execution pipeline 305 and performing addition operations on multiple operands for multiple vector elements for FMA execution pipeline 310. Stage 345 involves performing multiplies for transcendental execution pipeline 305 and performing normalization operations for multiple vector elements for FMA execution pipeline 310. Stage 350 involves performing addition operations for transcendental execution pipeline 305 and performing rounding operations for multiple vector elements for FMA execution pipeline 310. In stage 355, the data of transcendental execution pipeline 305 passes through a normalization and leading zero detection unit, and the outputs of the rounding stage are written to the vector destination cache for FMA execution pipeline 310. In stage 360, transcendental execution pipeline performs a rounding operation on the output from stage 355 and then the data is written to the vector destination cache. It is noted that in other embodiments, the transcendental execution pipeline 305 and/or FMA execution pipeline 310 can be structured differently.

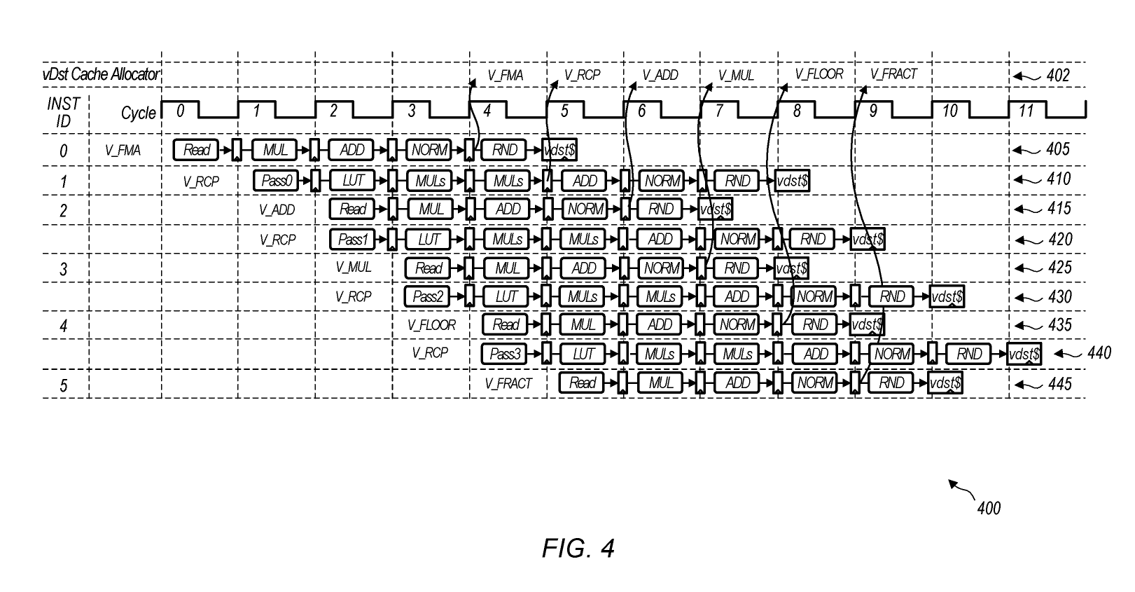

Turning now to FIG. 4, a timing diagram 400 of one embodiment of overlapped execution of processing pipelines is shown. It can be assumed for the purposes of this discussion that timing diagram 400 applies to the execution of instructions on transcendental execution pipeline 305 and FMA execution pipeline 310 of stream processor 300 (of FIG. 3). The instructions that are shown as being executed in timing diagram 400 are merely indicative of one particular embodiment. In other embodiments, other types of instructions can be executed on the transcendental execution pipeline and the FMA execution pipeline. The cycles shown for the instruction ID's indicate clock cycles for the stream processor.

In lane 405, which corresponds to instruction ID 0, a vector fused multiply-add (FMA) instruction is being executed on the FMA execution pipeline. Source data operands are read from the vector register file in cycle 0. Lane 410, which corresponds to instruction ID 1, illustrates the timing for a vector reciprocal instruction which is being executed on the transcendental execution pipeline. Pass 0 of the vector reciprocal instruction is initiated in cycle 1. In cycle 1, pass 0 of the vector reciprocal instruction reads all of the operands for the entire vector reciprocal instruction from the vector register file and stores them in temporary storage. It is noted that pass 0 refers to the first vector element being processed by the transcendental execution pipeline, with pass 1 referring to the second vector element being processed by the transcendental execution pipeline, and so on. In the embodiment illustrated by timing diagram 400, it is assumed that the width of the vector instructions is four elements. In other embodiments, other vector widths can be utilized.

Next, in cycle 2, a vector addition instruction is initiated on the FMA execution pipeline as shown in lane 415. Simultaneously with the vector addition instruction being initiated, in cycle 2, pass 1 of the vector reciprocal is initiated as shown in lane 420. The addition instruction shown in lane 415 accesses the vector register file in cycle 2, while pass 1 of the vector reciprocal instruction accesses an operand from the temporary storage. This prevents a conflict from occurring by preventing both the vector addition instruction and the vector reciprocal instruction from accessing the vector register file in the same clock cycle. By preventing a vector register file conflict, execution of the vector addition instruction of lane 415 is able to overlap with pass 1 of the vector reciprocal instruction shown in lane 420.

In cycle 3, the vector multiply instruction with instruction ID 3 is initiated on the FMA execution pipeline as shown in lane 425. Also in cycle 3, pass 2 of the vector reciprocal instruction is initiated on the transcendental execution pipeline as shown in lane 430. In cycle 4, the vector floor instruction with instruction ID 4 is initiated on the FMA execution pipeline as shown in lane 435. Also in cycle 4, pass 3 of the vector reciprocal instruction is initiated on the transcendental execution pipeline as shown in lane 440. In cycle 5, the vector fraction instruction with instruction ID 5 is initiated on the FMA execution pipeline as shown in lane 445. It is noted that in one embodiment, there are two write ports to the vector destination cache, allowing the transcendental execution pipeline and the FMA execution pipeline to write to the vector destination cache in the same clock cycle.

In lane 402, the timing of the allocation of cache lines in the vector destination cache is shown for the different instructions being executed on the execution pipelines. In one embodiment, cache lines are allocated early and aligned to avoid conflicts with allocations for other instructions. In cycle 4, a cache line is allocated in the vector destination cache for the FMA instruction shown in lane 405. In cycle 5, a cache line is allocated in the vector destination cache to store results for all four passes of the reciprocal instruction. In cycle 6, a cache line is allocated in the vector destination cache for the add instruction shown in lane 415. In cycle 7, a cache line is allocated in the vector destination cache for the multiply instruction shown in lane 425. In cycle 8, a cache line is allocated in the vector destination cache for the floor instruction shown in lane 435. In cycle 9, a cache line is allocated in the vector destination cache for the fraction instruction shown in lane 445. It is noted that two cache lines are not allocated in a single cycle since the cache line for the transcendental pipeline is allocated earlier during the first pass so that the allocation does not conflict with any of the instructions being executed on the FMA execution pipeline. It is also noted that multiple write ports are implemented for the vector destination cache to avoid write conflicts between the transcendental pipeline and the FMA execution pipeline.

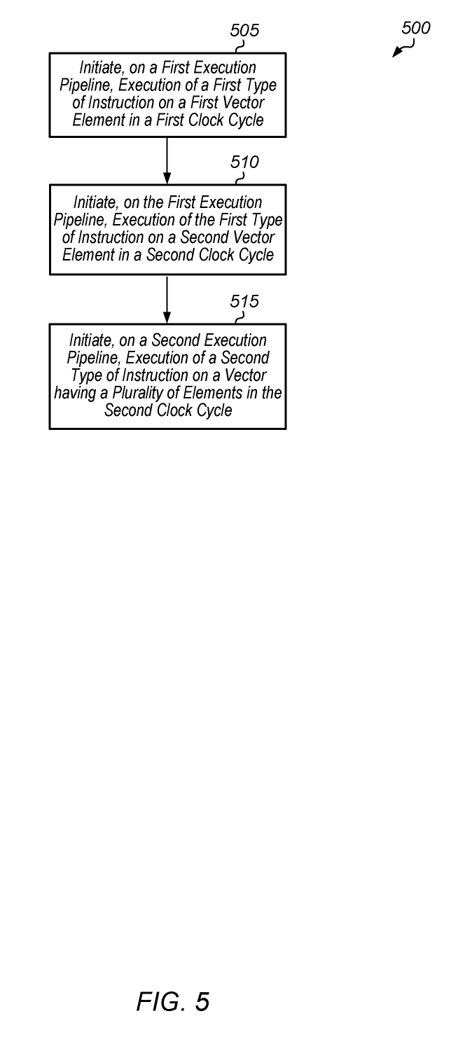

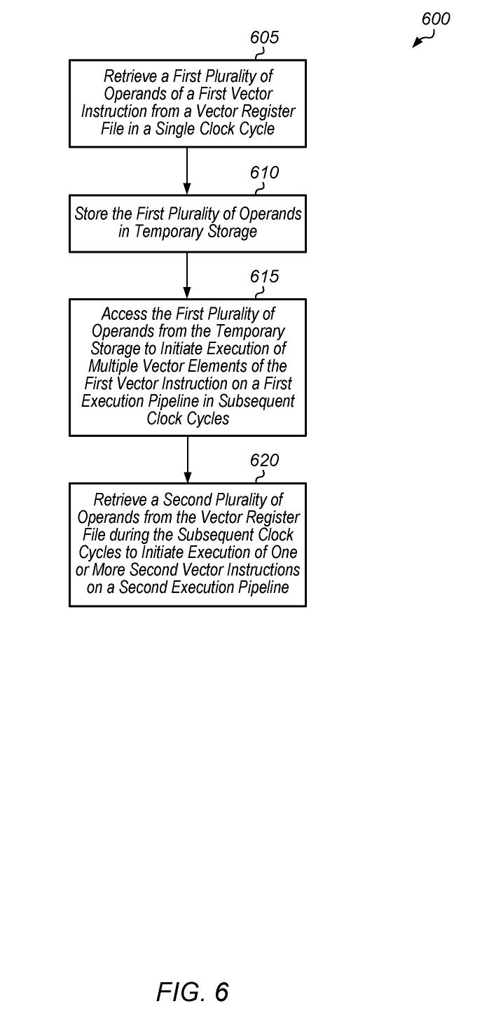

Referring now to FIG. 5, one embodiment of a method 500 for overlapping execution in multiple execution pipelines is shown. For purposes of discussion, the steps in this embodiment and those of FIG. 6 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

A processor initiates, on a first execution pipeline, execution of a first type of instruction on a first vector element in a first clock cycle (block 505). In one embodiment, the first execution pipeline is a transcendental pipeline and the first type of instruction is a vector transcendental instruction. It is noted that “initiating execution” is defined as providing operand(s) and/or an indication of the instruction to be performed to a first stage of an execution pipeline. The first stage of the execution pipeline then starts processing the operand(s) in accordance with the functionality of the processing elements of the first stage.

Next, the processor initiates, on the first execution pipeline, execution of the first type of instruction on a second vector element in a second clock cycle, wherein the second clock cycle is subsequent to the first clock cycle (block 510). Then, the processor initiates execution, on a second execution pipeline, of a second type of instruction on a vector having a plurality of elements in the second clock cycle (block 515). In one embodiment, the second execution pipeline is a vector arithmetic logic unit (VALU) and the second type of instruction is a vector fused multiply-add (FMA) instruction. After block 515, method 500 ends.

Turning now to FIG. 6, one embodiment of a method 600 for sharing a vector register file among multiple execution pipelines is shown. A first plurality of operands of a first vector instruction are retrieved from a vector register file in a single clock cycle (block 605). Next, the first plurality of operands are stored in temporary storage (block 610). In one embodiment, the temporary storage includes a plurality of flip-flops coupled to outputs of the vector register file.

Then, the first plurality of operands are accessed from the temporary storage to initiate execution of multiple vector elements of the first vector instruction on a first execution pipeline in subsequent clock cycles (block 615). It is noted that the first execution pipeline does not access the vector register file during the subsequent clock cycles. Additionally, a second plurality of operands are retrieved from the vector register file during the subsequent clock cycles to initiate execution of one or more second vector instructions on the second execution pipeline (block 620). It is noted that the second execution pipeline can access the vector register file multiple times during the subsequent clock cycles to initiate multiple second vector instructions on the second execution pipeline. Since the first execution pipeline is not accessing the vector register file during the subsequent clock cycles, the second execution pipeline is able to access the vector register file to obtain operands for executing overlapping instructions. After block 620, method 600 ends.

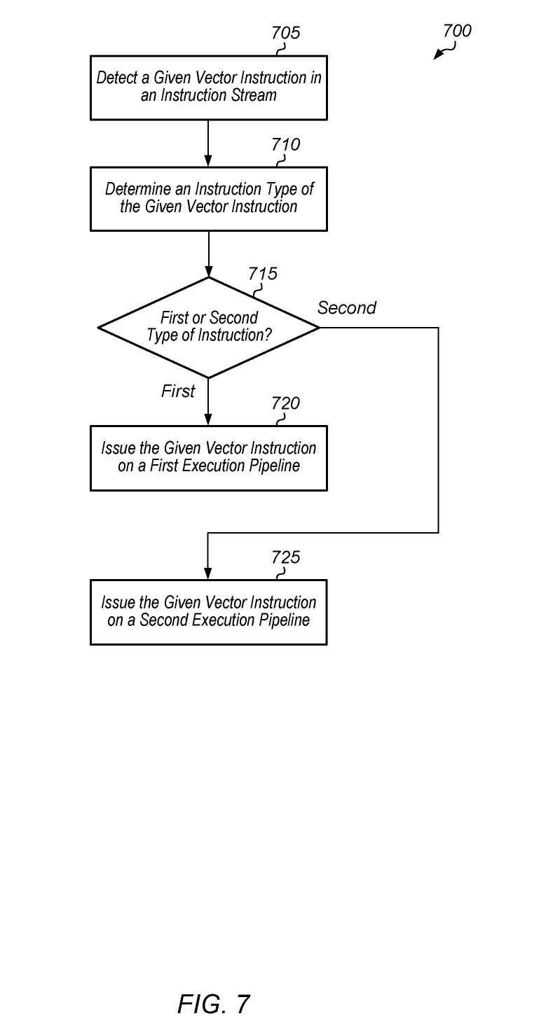

Referring now to FIG. 7, one embodiment of a method 700 for determining on which pipeline to execute a given vector instruction is shown. A processor detects a given vector instruction in an instruction stream (block 705). Next, the processor determines a type of instruction of the given vector instruction (block 710). If the given vector instruction is a first type of instruction (conditional block 715, “first” leg), then the processor issues the given vector instruction on a first execution pipeline (block 720). In one embodiment, the first type of instruction is a vector transcendental instruction and the first execution pipeline is a scalar transcendental pipeline.

Otherwise, if the given vector instruction is a first type of instruction (conditional block 715, “first” leg), then the processor issues the given vector instruction on a first execution pipeline (block 725). In one embodiment, the second type of instruction is a vector fused multiply-add instruction and the second execution pipeline is a vector arithmetic logic unit (VALU). After blocks 720 and 725, method 700 ends. It is noted that method 700 can be performed for each vector instruction detected in the instruction stream.

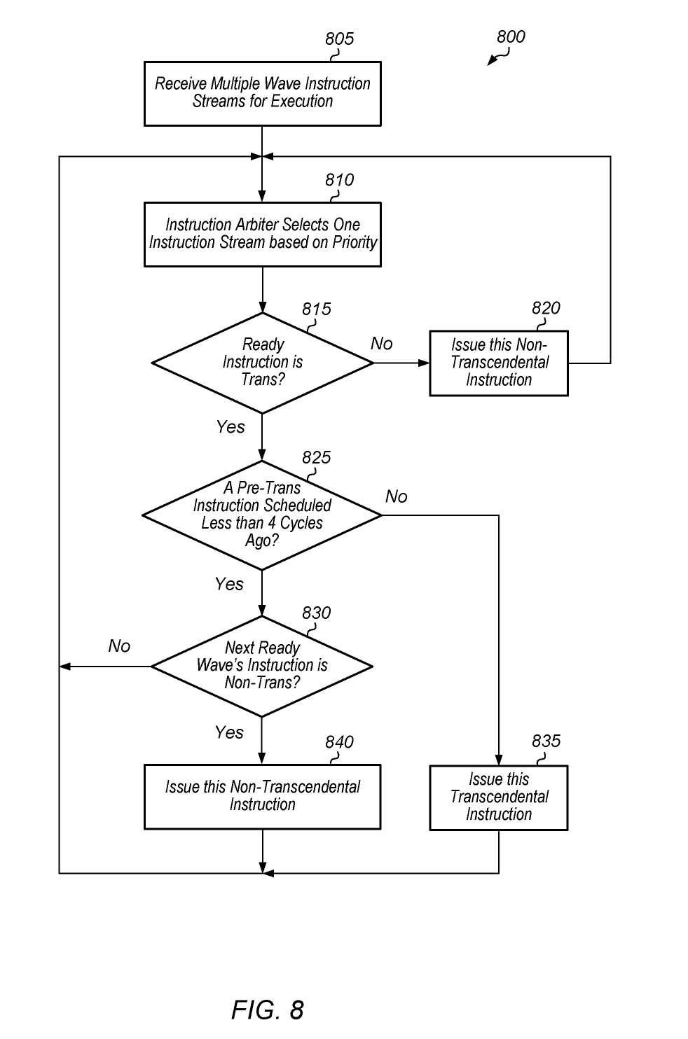

Turning now to FIG. 8, one embodiment of a method 800 for implementing an instruction arbiter is shown. An instruction arbiter receives multiple wave instruction streams for execution (block 805). The instruction arbiter selects one instruction stream for execution based on the priority of the streams (block 810). Next, the instruction arbiter determines if a ready instruction from the selected instruction stream is a transcendental instruction (conditional block 815). If the ready instruction is a transcendental instruction (conditional block 815, “yes” leg), then the instruction arbiter determines if a pre-transcendental instruction was scheduled less than four cycles ago (conditional block 825). It is noted that the use of four cycles in conditional block 825 is pipeline dependent. In other embodiments, other numbers of cycles besides four can be used in the determination performed for conditional block 825. If the ready instruction is not a transcendental instruction (conditional block 815, “no” leg), then the instruction arbiter issues this non-transcendental instruction (block 820). After block 820, method 800 returns to block 810.

If a pre-transcendental instruction was scheduled less than four cycles ago (conditional block 825, “yes” leg), then the instruction arbiter determines if the next ready wave's instruction is a non-transcendental instruction (conditional block 830). If a pre-transcendental instruction was not scheduled less than four cycles ago (conditional block 825, “no” leg), then the instruction arbiter issues this transcendental instruction (block 835). After block 835, method 800 returns to block 810. If the next ready wave's instruction is a non-transcendental instruction (conditional block 830, “yes” leg), then the instruction arbiter issues this non-transcendental instruction (block 840). After block 840, method 800 returns to block 810. If the next ready wave's instruction is a transcendental instruction (conditional block 830, “no” leg), then method 800 returns to block 810.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a first execution pipeline;
a second execution pipeline in parallel with the first pipeline; and
a vector register file shared by the first execution pipeline and the second execution pipeline;
wherein the system is configured to:
initiate, on the first execution pipeline, execution of a first type of instruction on a first vector element of a first vector in a first clock cycle;
initiate, on the first execution pipeline, execution of the first type of instruction on a second vector element of the first vector in a second clock cycle, wherein the second clock cycle is subsequent to the first clock cycle; and
initiate, on the second execution pipeline, execution of a second type of instruction on multiple vector elements of a second vector in the second clock cycle.

2. The system as recited in claim 1, wherein the vector register file comprises a single read port to convey operands to only one execution pipeline per clock cycle, and wherein the system is configured to:
retrieve, from the vector register file in a single clock cycle, a first plurality of operands of a first vector instruction;
store the first plurality of operands in temporary storage; and
access, from the temporary storage, the first plurality of operands to initiate execution of the first vector instruction on multiple vector elements on the first execution pipeline in subsequent clock cycles.

3. The system as recited in claim 2, wherein the system is configured to retrieve, from the vector register file, a second plurality of operands during the subsequent clock cycles to initiate execution of one or more second vector instructions on the second execution pipeline.

4. The system as recited in claim 1, wherein the first execution pipeline is a transcendental pipeline, and wherein the transcendental pipeline comprises a lookup stage followed by first and second multiply stages, followed by an add stage, followed by a normalization stage, and followed by a rounding stage.

5. The system as recited in claim 4, wherein the system is further configured to initiate execution of the one or more second vector instructions on the second execution pipeline responsive to determining there are no dependencies between the one or more second vector instructions and the first vector instruction.

6. The system as recited in claim 1, wherein:
the first type of instruction is a vector transcendental instruction;
the first execution pipeline is a scalar transcendental pipeline;
the second type of instruction is a vector fused multiply-add instruction; and
the second execution pipeline is a vector arithmetic logic unit.

7. The system as recited in claim 1, wherein the system is further configured to:
detect a first vector instruction;
determine a type of instruction of the first vector instruction;
issue the first vector instruction on the first execution pipeline responsive to determining the first vector instruction is the first type of instruction; and
issue the first vector instruction on the second execution pipeline responsive to determining the first vector instruction is the second type of instruction.

8. A method comprising:
initiating, on a first execution pipeline, execution of a first type of instruction on a first vector element of a first vector in a first clock cycle;
initiating, on the first execution pipeline, execution of the first type of instruction on a second vector element of the first vector in a second clock cycle, wherein the second clock cycle is subsequent to the first clock cycle; and
initiating, on the second execution pipeline, execution of a second type of instruction on multiple vector elements of a second vector in the second clock cycle.

9. The method as recited in claim 8, wherein the vector register file comprises a single read port to convey operands to only one execution pipeline per clock cycle, and wherein the method further comprising:
retrieving, from the vector register file in a single clock cycle, a first plurality of operands of a first vector instruction;
storing the first plurality of operands in temporary storage; and
accessing, from the temporary storage, the first plurality of operands to initiate execution of the first vector instruction on multiple vector elements on the first execution pipeline in subsequent clock cycles.

10. The method as recited in claim 9, further comprising retrieving, from the vector register file, a second plurality of operands during the subsequent clock cycles to initiate execution of one or more second vector instructions on the second execution pipeline.

11. The method as recited in claim 9, wherein the first execution pipeline is a transcendental pipeline, and wherein the transcendental pipeline comprises a lookup stage followed by first and second multiply stages, followed by an add stage, followed by a normalization stage, and followed by a rounding stage.

12. The method as recited in claim 11, further comprising initiating execution of the one or more second vector instructions on the second execution pipeline responsive to determining there are no dependencies between the one or more second vector instructions and the first vector instruction.

13. The method as recited in claim 8, wherein:
the first type of instruction is a vector transcendental instruction;
the first execution pipeline is a scalar transcendental pipeline;
the second type of instruction is a vector fused multiply-add instruction; and
the second execution pipeline is a vector arithmetic logic unit.

14. The method as recited in claim 8, further comprising:
detecting a first vector instruction;
determining a type of instruction of the first vector instruction;
issuing the first vector instruction on the first execution pipeline responsive to determining the first vector instruction is the first type of instruction; and
issuing the first vector instruction on the second execution pipeline responsive to determining the first vector instruction is the second type of instruction.

15. An apparatus comprising:
a first execution pipeline; and
a second execution pipeline in parallel with the first pipeline;
wherein the apparatus is configured to:
initiate, on the first execution pipeline, execution of a first type of instruction on a first vector element of a first vector in a first clock cycle;
initiate, on the first execution pipeline, execution of the first type of instruction on a second vector element of the first vector in a second clock cycle, wherein the second clock cycle is subsequent to the first clock cycle; and
initiate, on the second execution pipeline, execution of a second type of instruction on multiple vector elements of a second vector in the second clock cycle.

16. The apparatus as recited in claim 15, wherein the apparatus further comprises a vector register file shared by the first execution pipeline and the second execution pipeline, wherein the vector register file comprises a single read port to convey operands to only one execution pipeline per clock cycle, and wherein the apparatus is further configured to:
retrieve, from the vector register file in a single clock cycle, a first plurality of operands of a first vector instruction;
store the first plurality of operands in temporary storage; and
access, from the temporary storage, the first plurality of operands to initiate execution of multiple vector elements of the first vector instruction on the first execution pipeline in subsequent clock cycles.

17. The apparatus as recited in claim 16, wherein the apparatus is configured to retrieve, from the vector register file, a second plurality of operands during the subsequent clock cycles to initiate execution of one or more second vector instructions on the second execution pipeline.

18. The apparatus as recited in claim 16, wherein the first execution pipeline is a transcendental pipeline, and wherein the transcendental pipeline comprises a lookup stage followed by first and second multiply stages, followed by an add stage, followed by a normalization stage, and followed by a rounding stage.

19. The apparatus as recited in claim 18, wherein the apparatus is further configured to initiate execution of the one or more second vector instructions on the second execution pipeline responsive to determining there are no dependencies between the one or more second vector instructions and the first vector instruction.

20. The apparatus as recited in claim 15, wherein:
the first type of instruction is a vector transcendental instruction;
the first execution pipeline is a scalar transcendental pipeline;
the second type of instruction is a vector fused multiply-add instruction; and
the second execution pipeline is a vector arithmetic logic unit.
